(19) United States
(12) Patent Application Publication
(10) Pub. No.: US 2011/0277351 A1
(43) Pub. Date: Nov. 17, 2011

(54) SHOES FOR HAR-TRU, CLAY AND OTHER SIMILAR GRANULAR SURFACES

(76) Inventor: JIM SCOLEDES, Islamorada, FL (US)

(21) Appl. No.: 12/779,974

(22) Filed: May 14, 2010

(51) Int. Cl. A43B 13/04; B29C 45/14; A43D 11/14; A43B 5/10; A43B 13/12

(52) U.S. Cl. 36/103; 36/115; 12/146 B; 264/129

(57) ABSTRACT

A tennis shoe comprising, at least one upper shoe, at least one tying mechanism, the tying mechanism, deposed on the upper shoe; and at least one shoe-sole. The shoe-sole is coupled to said upper shoe, and further defining at least one shoe-sole-cavity concavely indented into the at least one shoe-sole and further defining at least one rib; where the at least one shoe-sole creates friction against gravel surfaces with said at least one rib. The method of making the shoe-sole described herein includes the injection molding at least one shoe-sole; selectively depositing at least one bubble; selectively leaving dense parts of materials; selectively molding at least one shoe-sole-cavity; selectively deposing at least one high strength material; and selectively deposing at least one slippery material. The method of making may occurs almost simultaneously using a single machine.

### FIELD OF THE INVENTION

The present invention relates to the art of athletic shoes.

### CROSS REFERENCE TO RELATED APPLICATIONS

Not applicable.

### STATEMENT REGARDING FEDERALLY-SPONSORED RESEARCH AND DEVELOPMENT

Not applicable.

### BACKGROUND OF THE INVENTION

The evolution of specialized athletic shoes can be traced to unconnected events in England and the United States. The “plimsoll” was the first mass-produced canvas, rubber-soled shoe. As tennis became more popular in the later part of the nineteenth century, the plimsoll became the first English all-purpose sport shoe.

Tennis is a sport that is very hard on shoes, and tennis shoes must be able to support all the stops and starts a player have to make, and it must give good support at the sides of the feet. Each surface has differing requirements, thus placing different demands on tennis shoes.

The most important consideration is what type of surface the tennis player is playing at. This is important because that will determine how much cushioning, where in the shoe, what kind of lateral support and how much friction to the surface will be needed. For example, one issue when playing in Har-Tru or clay surfaces, is that friction to the court is always lost since small pieces of rock and clay seal the canals in the sole creating a smooth surface.

In tennis, because much of your running on a court is side to side, the most important object of a tennis shoe is traction against the surface, and there arises the dangers of turning an ankle. Good traction is necessary especially if the tennis player is heavy or to avoid injury to the knees and ankles. The issue here again is that conventional tennis shoes do not accommodate for playing in dirt surfaces since the “grip” or traction to the surface becomes less as the player increases movement on the court.

Another issue with todays tennis shoes not adapted for use in clay or gravel surfaces, is that once off the court, the tennis shoe carries off clay-dirt to the locker room, car, and even the user's home. It is very difficult for the tennis player to get rid of all the unwanted clay after playing in a clay court. Even thought, some courts provide brushes, the dirt gets stuck into the small crevices of shoe-sole and will be carried around. The only solution to clean today's tennis shoes is by using water to rinse dirt away the shoe thus compromising the leather and other structural elements of the shoe to fungus and bad smell.

There is a need in today's marketplace to create a tennis shoe that is able to get superior traction on clay or Har-Tru tennis courts. A shoe that is designed to prevent soil, mud, small stones, and gravel from entering the grooves in the sole and at the same time is comfortable and creates grip. Moreover, in the tennis shoe industry, it would be desirable to progress from the small grooved shoe, to a shoe that allows the player maximum grip of the surface while not sacrificing speed and movement freedom on the court.

### BRIEF DESCRIPTION OF THE SEVERAL VIEWS OF THE DRAWINGS

The foregoing summary, as well as the following detailed description of the invention, will be better understood when read in conjunction with the appended drawings. For illustrating the invention, the figures are shown in the embodiments that are presently preferred. It should be understood, however, that the invention is not limited to the precise arrangements and instrumentalities shown. In the drawings:

FIG. 1 depicts at least one embodiment of the invention, namely a tennis shoe design comprising a composite shoe-sole.

FIG. 2 depicts at least one embodiment of the invention, namely bottom view of the inventive shoe-sole.

FIG. 3 depicts at least one embodiment of the invention, namely a cross-section of the inventive shoe comprising a composite dense, porous, slippery, rib cavity shoe-sole.

FIG. 4 depicts at least one embodiment of the invention, namely a close up view of the high strength rubber treatment, and the strategically deposed porous treatment incorporated into the shoe-sole.

FIG. 5 depicts at least one embodiment of the invention, namely a close up view of one shoe-sole cavity further depicting the dense part of the shoe-sole.

FIG. 6 depicts at least one embodiment of the invention, namely, the back side of the shoe-sole.

FIG. 7 depicts at least one embodiment of the invention, namely, a shoe-sole comprising four cavities.

FIG. 8 depicts at least one embodiment of the invention, namely, a shoe-sole comprising one cavity.

FIG. 9 depicts at least one embodiment of the invention, namely, a shoe-sole comprising two cavities.

### DESCRIPTION OF THE INVENTION

The present invention depicts an inventive solution to the fore mentioned issues related to tennis shoes.

Unless otherwise defined, all terms of art, notations and other scientific terms or terminology used herein are intended to have the meanings commonly understood by those of skill in the art to which this invention pertains. In some cases, terms with commonly understood meanings are defined herein for clarity and/or for ready reference, and the inclusion of such definitions herein should not necessarily be construed to represent a substantial difference over what is generally understood in the art. Many of the techniques and procedures described, or referenced herein, are well understood and commonly employed using conventional methodology by those skilled in the art. As appropriate, procedures involving the use of commercially available kits and reagents are generally carried out according to manufacturer defined protocols and/or parameters, unless otherwise noted.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, or should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as only one of or “exactly one of,” or, when used in the claims, “consisting of,” will refer to the inclusion of exactly one element of a number or list of elements. In general, the term or as used herein shall only be interpreted as indicating exclusive alternatives (i.e. one or the other but not both“) when preceded by terms of exclusivity, such as “either” one of,” “only one of,” or “exactly one of.” “Consisting essentially of,” when used in the claims, shall have its ordinary meaning as used in the field of patent law.

As used herein in the specification and in the claims, “gravel” or “clay” should be understood to have the same meaning as “crushed rock” as defined herein. Gravel is comprised small stones and pebbles, or a mixture of these with sand. HAR-TRU® is a registered trademark and the gravel is made from billion year old, Pre-Cambrian metabasalt. It is a natural green stone which is extremely hard and angular, two very important qualities when it comes to tennis court construction. The angularity helps the stone particles lock together to form a stable playing surface. The chemical composition of Har-Tru is mostly Basalt which Composition typically contains feldspar, mica, and chlorite among other naturally occurring minerals, some Gypsum (calcium sulfate) and some Crystalline Silica (quartz). Any type of sand or gravel stone can be use for the same purpose to achieve the same result on the tennis courts surface.

Avid tennis players know that different sorts of court surfaces 304 significantly vary and influence their play. After years of playing the game, the inventors herein discovered that the friction (traction) to the court's surface is more important for fast player response than surface area contact. Hence, more missed balls and errors accrued with shoes with higher surface area contact on courts that made some degree of sliding possible (clay or gravel) that on pavement or cement.

Tennis shoes represent the one piece of equipment that makes a big difference both during training and in competitions. While playing, the effort and stress that the feet have to bear against the shoe-sole could often lead to lack of grip against the court surface and catastrophic falls. Tennis players have to run, move sideways, back and forth, putting a great amount of pressure on their feet. This in turn places pressure over the surface area of the shoe-sole. In order to make sharp stops and go, the player need not to slip on to the court's surface. In gravel or clay surfaces, the small crevices and indentations in today's shoes are (usually great for indoor of non-gravel surfaces) a liability once the crevices and indentation are filled with dirt. Today's shoe-sole becomes a large flat slippery surface. In gravel or clay surfaces, slipping can be minimized if the pressure placed on the shoe can be greatly increased by reducing the surface area of grip, since the smaller contact areas have more friction and traction.

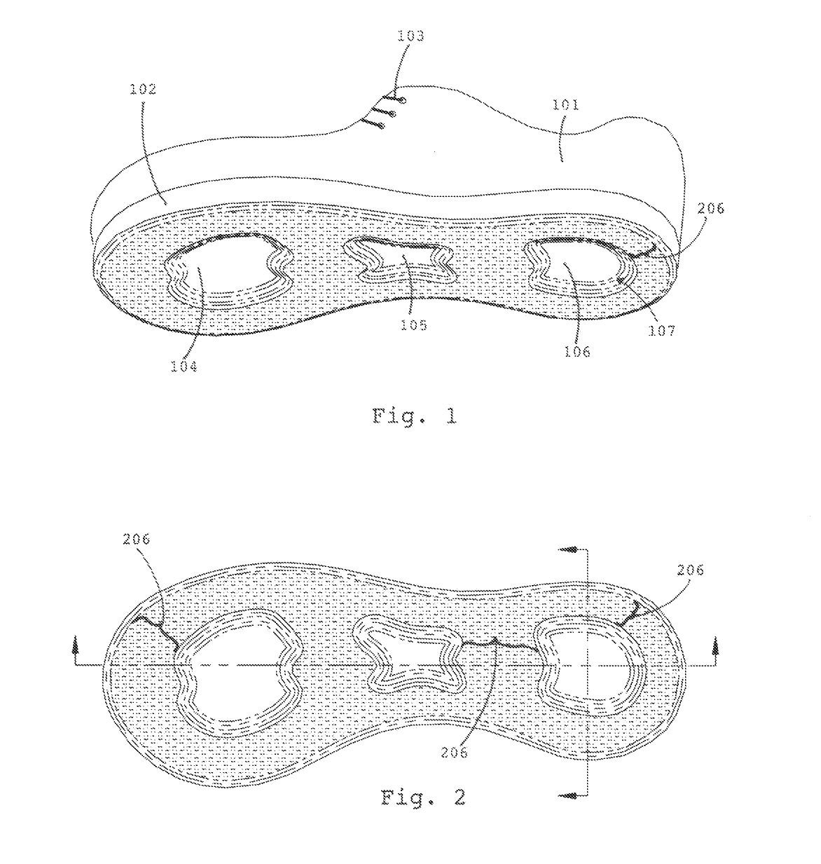

The inventors herein, after may years of trial, error, and validation from results of studies in biomechanics, developed a solution for slippage in gravel surfaces. The chief purposes of the inventive tennis shoe-sole herein are the combined functions of stability, flexibility, protection of the foot, and most importantly maximum traction on the running surface. To achieve these purposes, gravel tennis shoe-sole research created the utilization of lighter materials by inducing localized air, and a pressure distributing sole design encouraging an efficient brake system against slippage in gravel surfaces. During play, the friction coefficient of the gravel court against the shoe-sole is the most important aspect of the game. To maintain maximum agility during sharp turns and quick stops, the tennis shoe of FIG. 1 was developed.

In one embodiment of the invention, the FIG. 1 tennis shoe, is comprised of the upper shoe 101, the shoe-sole 102 coupled with the upper-shoe, the tying mechanism 103, a first sole-sole cavity 104, second shoe-sole cavity 105, and a third shoe-sole cavity 106. All the shoe-sole cavities 104-106 are concave into the shoe-sole 102 and further comprise at least one cavity wall radius 107. It is understood that a person skilled in the art, may modify the invention herein to incorporate more or less shoe-sole cavities that are equivalents, serve a similar purpose, and achieve the same kind of result. This can be seen in FIG. 7-FIG. 9. The cavity wall radius 107, may also be changed by the skilled in the art by creating a hyperbole instead of a circular arc of different diameters and roundness.

Coupled herein means glued or attached to the other elements surface by means of glue or by mechanical elements, such as staples or nails, to cause it to remain to be fixed steadily. In the context of shoe-sole-cavity, concavely indented means, ushed down, hollow, indented, recessed, set back, sunken into the shoe-sole by mechanically cutting, thermally removing, and using other thermoplastic forming means or any combination thereof.

The invention described in FIG. 2, is meant to be mostly used on court surfaces 304 that incorporates a wide range of court types, such as clay, grass, (synthetic) grass and various forms of soft courts. Har-tru®, gravel, clay or small stone surface 304 in which the invention herein would be preferred to be used. Nevertheless the inventive sole design of FIG. 2 has been tested and used in other types of surfaces such as pavement, rubber, indoor and outdoor concrete courts. The grip or traction results on those surfaces were not as encouraging as the results for gravel type courts.

In the sport of tennis, the types of movement performed include jumping, turning, sliding, quick starting and quick stopping. In all of these, extreme pressure is put on the foot, the lower leg and the knee, but the shoe-sole 102 is the one element that has to make the friction against the court's surface. For example, in a half-meter high jump to hit a smash, the force of the landing is equal to four times his total body weight and this is transformed in to pressure on the sole. The inventive invention herein, advantageously uses this pressure to create more friction against the court.

P=F/(L*L)

Pressure equals to the Force divided by two lengths or Area. This old formula was inventively used to increase the traction of the tennis shoe-sole rib 206. For gavel surfaces 304, (were small particles of rocks make the coefficient of friction lower than pavement or flat courts) hence more rib 206 pressure and smaller surface area resulted higher traction. The inventive invention not only increases pressure against the court through ribs 206, but the sole cavities 104, 105, and 106 also prevent gravel from creating a more slippage as it repels stones or clay form sticking to the cavity walls.

FIG. 3 depicts at least one embodiment of the invention, namely a cross-section of the inventive tennis shoe comprising, upper shoe 101, the inner sole 302, and the outer composite shoe-sole 102. The outer composite shoe-sole comprises four types of material sections, porous 301, high strength 401, dense 303 and slippery 501. Each material section has a particular treatment with a particular purpose within the shoe-sole.

The porous 301 section is mainly for shock absorption and the pores strategically deposited in to the sole composite. The composite tennis shoe-sole 102 was constructed so that that it is able to absorb the shock on whichever part of the foot the player lands, the heel, or the inner and outer sides of the foot, as depicted in FIG. 2. This is achieved by strategically deposing air bubbles that are injected in the polymer material at the time of making in the injection mold. The targeted air bubbles 301 creates a porous, very shock absorbent material property wherever is needed only 206, leaving denser sections where needed 303.

The type of manufacturing treatment used for the sole 102 is comprises at least one inventive element invention herein. The inventive shoe-sole of FIG. 3 comprises a porous section 201, a dense not porous treatment 303, and a stiffer high strength rubber 401 patterned or textured 401 to create friction. The dense 303 section was mainly created for durability and stability of the sole. This rubber section 401 is attached once the composite shoe-sole is cooled after injection molding by means of liquid rubber or glue.

The stiffness of 303 creates a counter balance against the flexible shock absorption of 301. The inventive composite shoe-sole 102 becomes neither too stiff nor too flexible. A tennis shoe-sole that is too flexible causes the player to experience pain in the arch of the foot, whereas with a shoe that is too stiff problems will be more commonly experienced in the toes, ankles and knees. The excessively flexible shoe allows too much supination, and the stiff shoe too little. The inventive shoe-sole 102 mixes both stiff and flexible materials to create a balanced combination.

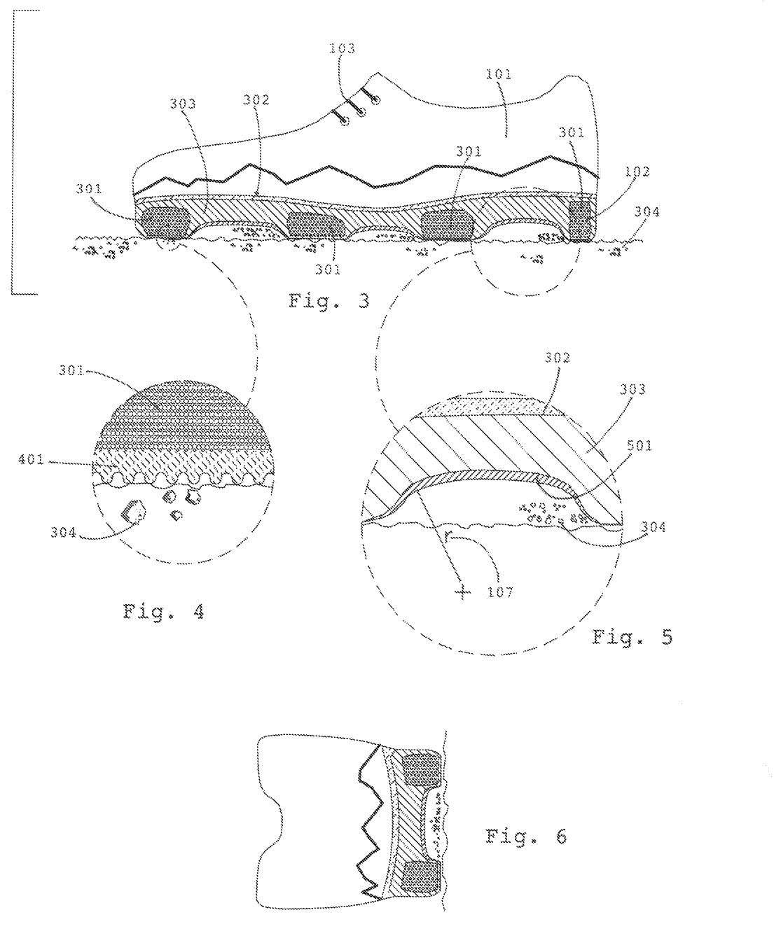

FIG. 4 depicts the thin, hard rubber 401 was also made by injection molding synthetic rubber, or thermoplastic elastomers for high traction and durability. The inventors found that the more pronounced the pattern, the stiffer the rubber will be. Typical synthetic rubbers that can be used for the same purpose to achieve the same result are Polyurethane, Styrene Butadiene, Styrene Ethylene/Butylene Styrene and Polysiloxane.

The dense, not porous material 303, and the porous material 201 is same material namely ethylene vinyl acetate (known in the art as EVA) copolymer of ethylene and vinyl acetate, the only difference between 201 and 201 is the amount and size of the bubbles of air (air pockets). The pockets of air are between two and four thirty-second's of an inch in diameter. Minor variation in bubble size would be equivalent, serve a similar purpose, and achieve the same kind of result. The inner shoe-sole 203 and 204, was constructed of lightweight plastic and nylon materials. The materials were purchased from Remington Products, in Wadsworth Ohio, and were injection molded.

The cavity coating 501, of FIG. 5, is an element of the invention herein that has the purpose of repelling away small stones 303 and particles from any of the sole cavities 104-106. The cavity coating 501 is made of silicone, that is sprayed onto the surface of the cavity though a mask after the shoe-sole cools. Fluoropolymer of tetrafluoroethylene (teflon), Perfluoroalkoxy and Fluorinated ethylene propylene would be equivalent, serve a similar purpose, and achieve the same kind of result. After some experimentation, the inventors discovered that the coating 501 and the cavity wall radius 107, prevented clay, gravel or Har-Tru 303 from sticking to the walls of the sole cavities 104-106, thus solving the above mentioned issues with clay or gravel courts 304.

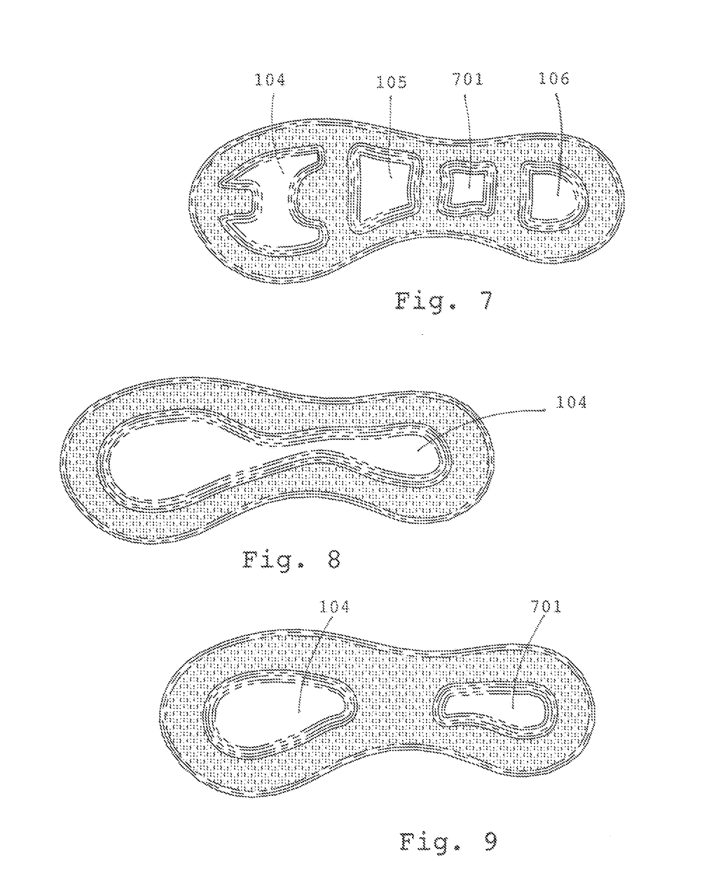

FIG. 7, depicts an embodiment of the invention, namely a four cavity tennis shoe-sole that was made using the materials and method described above. FIG. 8 depicts another embodiment of the invention, namely an elongated cavity 104 that covers from the front of the shoe to the back of the shoe. FIG. 9 depicts yet another embodiment of the invention namely two cavities 104 and 701. Notice that the shape of the cavity 104 is not an important element of the invention and any shape would be equivalent, serve a similar purpose, and achieve the same kind of result. Nevertheless, the shoe-sole rib 206, is constant throughout the outer perimeter of the shoe although small variations in thickness of the rib 206 would be equivalent, serve a similar purpose, and achieve the same kind of result.

The method of making a shoe-sole described herein includes the injection molding at least one shoe-sole 102; selectively depositing at least one bubble 301 on said at least one shoe-sole; selectively leaving dense parts of materials 303 on said at least one shoe-sole; selectively molding at least one shoe-sole-cavity 104 on said at least one shoe-sole; selectively deposing at least one high strength material 401 on said at least one shoe-sole; and selectively deposing at least one slippery material 501 on said at least one shoe-sole. The method of making may occurs almost simultaneously using a single machine.

The tennis shoes of FIG. 1 represents the concept of the inventive tennis shoe for gravel and clay surfaces 304. The resilient material 301 can do wonders offering heel strike and bounce back, and the stiff material 206 helping the player come to a quick stop without sliding and to sprint better. The rib 206 creates more traction since it exhorts more pressure on the grained 303 surface 304. All of this included in a single 102 shoe-sole platform that does not retain any clay or rocks after playing in the court.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention.

We claim:

1. A tennis shoe comprising:
at least one upper shoe;
at least one tying mechanism, said tying mechanism, deposed on said upper shoe; and
at least one shoe-sole, said shoe-sole coupled to said upper shoe, said shoe-sole further defining at least one shoe-sole-cavity concavely indented into said at least one shoe-sole and further defining at least one rib;
wherein said at least one shoe-sole creates friction against gravel surfaces with said at least one rib.

2. The tennis shoe of claim 1, wherein said at least one shoe-sole-cavity further comprising at least one cavity radius.

3. The tennis shoe of claim 1, wherein said at least one shoe-sole-cavity prevents dirt from accumulating with at least one slippery material selected from the group consisting of silicone, fluoropolymer of tetrafluoroethylene (teflon), perfluoroalkoxy and fluorinated ethylene propylene.

4. The tennis shoe of claim 1, wherein said at least one shoe-sole material comprises at least one porous treatment, at least one dense treatment, at least one high strength treatment, and at least one slippery treatment.

5. The tennis shoe of claim 1, wherein said at least one shoe-sole material is selected from the group consisting of copolymer of ethylene, vinyl acetate, polyurethane, styrene butadiene, styrene ethylene/butylene styrene, polysiloxane, low density polyethylene, linear low density polyethylene, high density polyethylene and combinations thereof.

6. The tennis shoe of claim 1, wherein said tennis shoe is to be used in gravel, crushed stone, Har-Tru and sand surfaces.

7. A composite shoe-sole comprising:
at least one porous section, said porous section further comprising air bubbles;
at least one dense section, said dense section further comprising at least one solid polymer material;
at least one slippery section,
and
at least one high strength section, said high strength section further comprising at least one rubber material.

8. The composite shoe-sole of claim 7, wherein said at least one shoe-sole further comprises at least one shoe-sole-cavity.

9. The composite shoe-sole of claim 7, wherein said at least one slippery section is selected from the group consisting of silicone, fluoropolymer of tetrafluoroethylene (teflon), perfluoroalkoxy and fluorinated ethylene propylene.

10. The composite shoe-sole of claim 7, wherein said at least one shoe-sole material is selected from the group consisting of copolymer of ethylene, vinyl acetate, polyurethane, styrene butadiene, ethylene/butylene Styrene, polysiloxane, low density polyethylene, linear low density polyethylene, high density polyethylene and combinations thereof.

11. The composite shoe-sole of claim 7, wherein said tennis shoe is to be used in gravel, crushed stone, Har-Tru and sand surfaces.

12. A method of making a shoe-sole comprising:
injection molding at least one shoe-sole;
selectively depositing at least one bubble on said at least one shoe-sole;
selectively leaving dense parts of materials on said at least one shoe-sole;
selectively molding at least one shoe-sole-cavity on said at least one shoe-sole;
selectively deposing at least one high strength material on said at least one shoe-sole;
and
selectively deposing at least one slippery material on said at least one shoe-sole,
wherein said at least one shoe-sole-cavity and said at least one slippery material prevents said at least one shoe-sole from slipping on gravel surfaces.

13. The method of claim 12, wherein said making occurs almost simultaneously.

14. The method of claim 12, wherein said at least one slippery section is selected from the group consisting of silicone, fluoropolymer of tetrafluoroethylene (teflon), Perfluoroalkoxy and Fluorinated ethylene propylene.

15. The method of claim 12, wherein said at least one shoe-sole material is selected from the group consisting of copolymer of ethylene, vinyl acetate, polyurethane, styrene Butadiene, styrene ethylene/butylene styrene, polysiloxane, low density polyethylene, linear low density polyethylene, high density polyethylene and combinations thereof.

16. The method of claim 12, wherein said tennis shoe is to be used in gravel, crushed stone, Har-Tru and sand surfaces.
